(19) United States
(12) Patent Application Publication
(10) Pub. No.: US 2006/0174314 A1
(43) Pub. Date: Aug. 3, 2006

(54) Methods and apparatus for hybrid multimedia presentations

(76) Inventors: Paul E. Jacobs, La Jolla, CA (US); Gordon Kent Walker, Poway, CA (US); Ravinder Paul Chandhok, Poway, CA (US)

Correspondence Address: QUALCOMM, INC, 5775 MOREHOUSE DR., SAN DIEGO, CA, 92121, US

(21) Appl. No.: 11/186,194

(22) Filed: Jul. 19, 2005

Related U.S. Application Data
(60) Provisional application No. 60/590,128, filed on Jul. 21, 2004.

(51) Int. Cl. H04N 7/16; H04N 7/173; H04N 5/445; G06F 13/00

(52) U.S. Cl. 725/135; 725/38; 725/90

(57) ABSTRACT

System for providing hierarchical services in a data network. A method is provided for rendering hybrid presentations. The method includes caching one or more content items, and detecting a presentation event associated with a real-time service. The method also includes retrieving a selected content item from the one or more content items based on the presentation event, and rendering the selected content item.

The present Application for Patent claims priority to Provisional Application No. 60/590,128 entitled “APPARATUS AND METHOD FOR PRESENTATIONS IN A HYBRID MULTIMEDIA” filed Jul. 21, 2004, and assigned to the assignee hereof and hereby expressly incorporated by reference herein.

### BACKGROUND

1. Field

The present invention relates generally to the operation of data networks, and more particularly, to methods and apparatus for providing hybrid multimedia presentations on a device.

2. Background

Data networks, such as wireless communication networks, have to trade off between services customized for a single terminal and services provided to a large number of terminals. For example, the distribution of multimedia content to a large number of resource-limited portable devices (subscribers) is a complicated problem. Therefore, it is very important for network administrators, content retailers, and service providers to have a way to distribute content and/or other network services in a fast and efficient manner for presentation on networked devices.

In current content delivery/media distribution systems, streaming real-time media is used to deliver content to a large number of devices. For example, streaming real-time media reduces the total memory required at the playback device and is; therefore, suitable for use with portable devices having limited memory resources. However, streaming real-time media usually requires some amount of acquisition time, and device users may choose to tune away during commercials in the real-time media. Additionally, significant bandwidth may be used transmit the same content, such as advertising, over and over again.

It is also possible for content delivery/media distribution systems to utilize caching to distribute non real-time media to a large number of devices. Cached non real-time media starts very quickly thereby overcoming the problem of slow acquisition time. Unfortunately, the caching technique may require that the entire non real-time presentation be cached prior to playback, which means that the playback device needs to have significant memory resources. As a result, caching large media presentations may not be suitable for use with resource limited portable devices.

Therefore, what is needed is a way to deliver a selected arrangement of real-time and non real-time media to a large number of devices that overcomes the problems associated with bandwidth utilization, media acquisition times, and device resource requirements. It would also be desirable to target selected subscribers to receive and render a selected arrangement or sequence of content based operational parameters, such as user subscription activity.

### SUMMARY

In one or more embodiments, a hybrid presentation system is provided that operates to render real-time and non real-time content on a device based on a variety of operational conditions. For example, the system operates to determine a particular arrangement, sequence, mixing, and/or selection of real-time and non-real-time content for presentation on a targeted device based on the occurrence of one or more presentation events.

In one embodiment, cached content items are linked to real-time media services to provide a crisp user experience on a device that otherwise might have sluggish interactivity. Selected content items, such as interface screens, advertisements, or other information items are cached so that minimal data transfers are needed for a transaction. Thus, device users perceive fast response and start-up times, and content retailers are able to easily and efficiently insert advertisements and other information into real-time services.

In one embodiment, a method is provided for rendering hybrid presentations. The method comprises caching one or more content items, and detecting a presentation event associated with a real-time service. The method also comprises retrieving a selected content item from the one or more content items based on the presentation event, and rendering the selected content item.

In one embodiment, an apparatus is provided for rendering hybrid presentations. The apparatus comprises memory configured to cache one or more content items, and client application logic configured to detect a presentation event associated with a real-time service, and to retrieve selected content item from the one or more content items based on the presentation event. The apparatus also comprises rendering logic configured to render the selected content item.

In one embodiment, an apparatus is provided for rendering hybrid presentations. The apparatus comprises means for caching one or more content items, and means for detecting a presentation event associated with a real-time service. The apparatus also comprises means for retrieving a selected content item from the one or more content items based on the presentation event, and means for rendering the selected content item.

In one embodiment, a computer-readable medium is provided that comprises instructions, which when executed by processing logic, operate to render hybrid presentations. The computer-readable medium comprises instructions for caching one or more content items and instructions for detecting a presentation event associated with a real-time service. The computer-readable medium also comprises instructions for retrieving a selected content item from the one or more content items based on the presentation event and instructions for rendering the selected content item.

In one embodiment, at least one processor is provided that is configured to perform a method for rendering hybrid presentations. The method comprises caching one or more content items and detecting a presentation event associated with a real-time service. The method also comprises retrieving a selected content item from the one or more content items based on the presentation event and rendering the selected content item.

In one embodiment, a method is provided for rendering hybrid presentations. The method comprises generating system information parameters for one or more real-time services, wherein the system information parameters associate a presentation event with a cacheable content item, and transmitting the system information parameters.

In one embodiment, an apparatus is provided for rendering hybrid presentations. The apparatus comprises logic for generating system information parameters for one or more real-time services, wherein the system information parameters associate a presentation event with a cacheable content item, and logic for transmitting the system information parameters.

Other aspects of the embodiments will become apparent after review of the hereinafter set forth Brief Description of the Drawings, Detailed Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows one embodiment of a network that comprises one embodiment of a hybrid presentation system;

FIG. 2 shows a detailed diagram of one embodiment of a server suitable for use in one or more embodiments of a hybrid presentation system;

FIG. 3 shows one embodiment of cacheable content for use in one or more embodiments of a hybrid presentation system;

FIG. 4 shows one embodiment of system information for use in one or more embodiments of a hybrid presentation system;

FIG. 5 shows one embodiment of a method for operating a server in one embodiment of a hybrid presentation system;

FIG. 6 shows a detailed diagram of one embodiment of a device suitable for use in one or more embodiments of a hybrid presentation system;

FIG. 7 shows one embodiment of a method for operating a device in one embodiment of a hybrid presentation system; and

FIG. 8 shows one embodiment of a method for operating a device to detect a presentation event in one embodiment of a hybrid presentation system.

### DETAILED DESCRIPTION

In one or more embodiments, a hybrid presentation system is provided that operates to render hybrid presentations on a device. For example, hybrid presentations comprise a particular arrangement, sequence, mixing, and/or selection of real-time and/or non-real-time content for presentation on a targeted device. The system is especially well suited for use in wireless network environments, but may be used in any type of network environment, including but not limited to, communication networks, public networks, such as the Internet, private networks, such as virtual private networks (VPN), local area networks, wide area networks, long haul networks, or any other type of data network.

The following definitions are used herein to describe one or more embodiments of a hybrid presentation system.
Service A service comprises a sequence of media presentations that represents the smallest element that may be subscribed to by a device.
Tier A tier is a collection of one or more services.
Package A package (or “Service Package”) comprises any combination of services and/or tiers that are offered on a subscription basis.

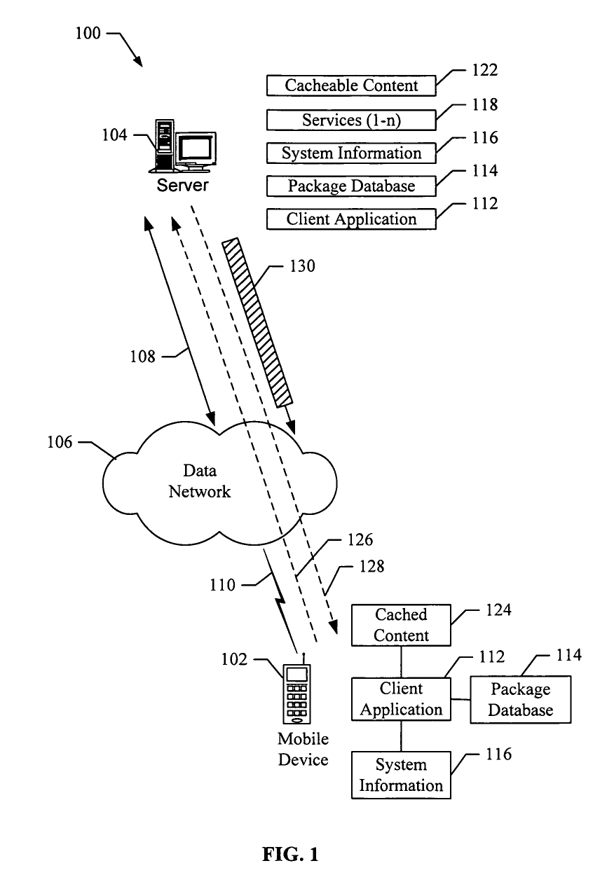

FIG. 1 shows one embodiment of a network 100 that comprises one embodiment of a hybrid presentation system. The network 100 comprises a mobile device 102, a server 104, and a data network 106.

In one embodiment, the server 104 operates to provide services that may be subscribed to by devices in communication with the network 106. The server 104 is coupled to the network 106 through the communication link 108. The communication link 108 comprises any suitable communication link, such as any combination of wired and/or wireless links that operates to allow the server 104 to communicate with the network 106. The network 106 comprises any combination of wired and/or wireless networks that allows services to be delivered from the server 104 to devices in communication with the network 106, such as the device 102.

The device 102 in this embodiment comprises a mobile telephone that communicates with the network 106 through the wireless link 110. It should be noted that other devices are possible within the scope of the embodiments. For example, other devices suitable for use in one or more embodiments of the hybrid presentation system include, but are not limited to, a personal digital assistant (PDA), email device, pager, a notebook computer, mp3 player, video player, or a desktop computer. The wireless link 110 comprises any suitable wireless communication link that operates to allow the device 102 to communicate with the network 106. The device 102 may also communicate with the network 106 utilizing a wired communication link.

The device 102 takes part in an activation process that allows the device 102 to subscribe to receive services over the network 106. In one embodiment, the activation process may be performed with the server 104; however, the activation process may also be performed with another server, service provider, content retailer, or any other entity. For the purpose of this description, it will be assumed that the device 102 performs the activation process with the server 104.

As part of the activation process, the device 102 provides a device identifier, manufacturer identifier, subscriber identifier, and/or any other information that may be used to authenticate/authorize the device 102 to subscribe to receive services from the server 104. After activation, the server 104 transmits a client application 112, a package database 114, and system information 116 to the device 102. It should be noted that in other embodiments, any of the client application 112, package database 114, and system information 116 may be transmitted to the device from another network entity, installed on the device during device manufacture, or downloaded from a local storage medium and activated as a result of the activation process.

The package database 114 comprises information that describes services that are available to which the device 102 may subscribe to receive. The client application 112 executes on the device 102 and processes the package database 114 to provide an interactive program guide that displays information about available services to the device user. The system information 116 comprises information relating to the available services, such as required device resources, associated cached content identifiers, or other system information.

In one embodiment, the server 104 comprises one or more services 118, and cacheable content 122. For example, the services 118 comprise multimedia content that includes news, sports, weather, financial information, movies, and/or applications, programs, scripts, or any other type of suitable content or service.

In one embodiment, the cacheable content 122 comprises content that may be rendered on a device. For example, the cacheable content 122 may comprise games or other applications, commercials, content plot variants based on user input with temporal significance, or other information having the ability to open essentially arbitrary file types, all of which may be rendered or executed on the device 102. For example, in one embodiment, the cacheable content 122 may comprise non-real-time content clips representing advertisements or other multimedia content.

In one embodiment, the system information 116 comprises information that associates content in the cacheable content 122 with one or more of the services 118. For example, the system information 124 associates one or more content clips that are part of the cacheable content 122 to a selected service that is part of the services 118.

In one embodiment, the cacheable content 122 is delivered over the network 106 from the server 104 to the device 102. For example, the cacheable content 122 is delivered to the device 102 and is stored as cached content 124 at the device 102. The cacheable content 122 is associated with the services that are available to the device 102.

It should be noted that the elements of the server 104 might be updated to reflect changes in the available information. For example, the services 118, system information 116, or cacheable content 122 may be updated or changed as necessary. When these changes occur, the server 104 operates to deliver the most recent information to the device 102. For example, the system information 116 may be transmitted to the device 102 according to a predefined schedule so that updates to the system information 116 may be received by the device within a selectable time interval. Furthermore, the delivery of information from the server 104 to the device 102 may be performed in the background using an “invisible service” that is part of the system but is not listed as an available service in the interactive program guide.

In one embodiment, the hybrid presentation system operates to perform one or more of the following functions to provide hybrid presentations at the device 102.
1. Render content that is part of the cached content 124 when the device 102 attempts to acquire a real-time service.
2. Render content that is part of the cached content 124 when the device exits a real-time service.
3. Render content that is part of the cached content 124 upon selected user activity. For example, the user activity may be based on the subscription status of the device or selected actions taken by the device user that do not include entry or exit from a real-time service.

In one embodiment, the hybrid presentation system renders a selected portion of the cached content 124 when the device 102 attempts to acquire a real-time service. For example, the client application 112 processes the package database 114 to provide the device user with a listing of available services. When the device user selects a particular service to receive, the client application 112 accesses information in the system information 116 that is associated with the selected service. The information in the system information 116 identifies selected content of the cached content 124 that is to be rendered when the device attempts to acquire the selected real-time service. The client application 112 then retrieves the selected content from the cached content 124 and renders it on the device. For example, the selected cached content may be an introduction for the service that is to be joined. The client application 112 then transmits a request 126 to the server 104 to acquire the selected service 130. The server responds by transmitting the selected service 130 to the device, as shown by path 128.

In one embodiment, the hybrid presentation system renders a selected portion of the cached content 124 when the device 102 attempts to exit a real-time service. Assuming the device is receiving a real-time service from the server 104, the device user may optionally choose to cancel or exit the service. For example, the device user may interact with the client application 112 to select one or more services to be exited, terminated, or unsubscribed. The client application 112 accesses information in the system information 116 that is associated with the selected service. The information in the system information 116 identifies content in the cached content 124 that is to be rendered when the device attempts to exit the selected real-time service. The client application 112 then retrieves the identified content from the cached content 124 and renders it on the device. For example, the content may be a summary of the service that is to be exited. The client application 112 then transmits a request to the server 104 to exit the selected service. The server 104 responds by terminating the transmission of the selected service to the device 102.

In one embodiment, the hybrid presentation system renders a selected portion of the cached content 124 in response to a selected user activity by the device user that does not include entry or exit from a real-time service. For example, assuming the device is receiving a real-time service, the device user may input information in response to pop-ups, information requests, or provide any other user action. Based on the user action, the client application 112 accesses information in the system information 116 that is associated with the selected user action. The information in the system information 116 identifies content in the cached content 124 that is to be rendered. The client application 112 then retrieves the content from cached content 124 and renders it on the device 102. For example, the content may be an advertisement based on the type of services or subscriptions associated with the device 102.

In one embodiment, the user activity is determined from the subscription status of the device. For example, the system information 116 contains subscription status information that is processed by the client application 112 to determine if selected conditions have been met. For example, the subscription status comprises information about the types of services subscribed to by the device, and may also comprise conditions based on a user profile, demographics associated with the device user, or any other type of subscription status information. Based on the subscription status, the client application 112 accesses information in the system information 116 that identifies content in the cached content 124 that is to be rendered. The client application 112 then retrieves the content from cached content 124 and renders it on the device 102. For example, the content may be an advertisement based on the type of services or subscriptions associated with the device 102.

Therefore, in one or more embodiments, a hybrid presentation system operates to provide hybrid presentations comprising a particular arrangement, sequence, mixing, and/or selection of real-time and non-real-time content for presentation on a device. It should be noted that the hybrid presentation system is not limited to the implementations described with reference to FIG. 1, and that other implementations are possible within the scope of the embodiments.

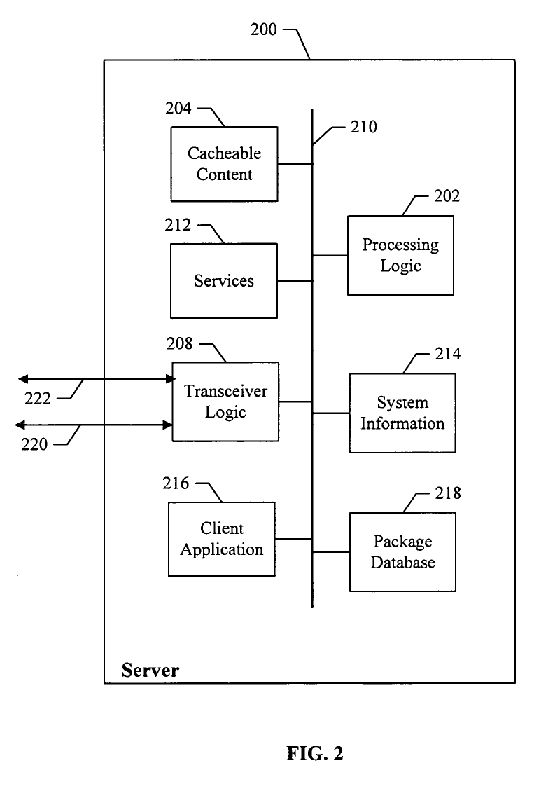

FIG. 2 shows a detailed diagram of one embodiment of a server 200 suitable for use in one or more embodiments of a hybrid presentation system. For example, the server 200 may be used as the server 104 in FIG. 1. The server 200 comprises processing logic 202, cacheable content 204, and transceiver logic 208, all coupled to an internal data bus 210. The server 200 also comprises services 212, system information 214, client application 216 and package database 218.

In one or more embodiments, the processing logic 202 comprises a CPU, processor, gate array, hardware logic, memory elements, virtual machine, software, and/or any combination of hardware and software. Thus, the processing logic 202 generally comprises logic to execute machine-readable instructions and to control one or more other functional elements of the server 200 via the internal data bus 210.

The cacheable content 204 comprises one or more content items to be distributed to devices over a data network. For example, the cacheable content 204 comprises a plurality of content items that are to be distributed over a data network for caching at one or more devices. In one or more embodiments, the cacheable content 204 comprises games or other applications, commercials, content plot variants, or other information having the ability to open essentially arbitrary file types, all of which may be rendered or executed on a device.

The services 212 comprise any type of real-time services including, but not limited to, multimedia presentations, news, sports, weather, financial information, and/or any other type of real-time services.

The transceiver logic 208 comprises hardware and/or software that operate to allow the server 200 to transmit and receive data and/or other information over a network connection. In one embodiment, the transceiver logic 208 comprises logic configured to provide a unicast communication channel 220 that provides any suitable type of unicast communication link to allow the server 200 to communicate with a device through a unicast transmission. In one embodiment, the transceiver logic 208 comprises logic configured to provide a multicast communication channel 222 that provides any suitable type of multicast communication link to allow the server 200 to communicate with one or more devices using a multicast transmission.

The package database 218 comprises information that describes the available service packages. For example, the package database 218 includes package and service descriptions, identifiers, pricing, scheduling and any other suitable information about available services and packages.

The client application 216 comprises a program or other type of executable that executes on a device to process the package database 218 to provide an interactive program guide to a device user. The interactive program guide allows the device user to see available services and make subscription selections.

The system information 214 comprises information pertaining to the services 212. For example, the system information 214 comprises resource identifiers, content identifiers, or any other system information associated with services that are available to a device. In one embodiment, the processing logic 202 operates to generate the system information parameters.

In one embodiment, devices go through an activation process with the server 200 in order to subscribe to receive one or more services 212 from the server 200. After the activation process, the server 200 transmits the client application 216, package database 218 and system information 214 to the activated devices.

During operation of one or more embodiments of a hybrid presentation system, the server 200 transmits a portion of the cacheable content 204 over a data network to be cached at the device. In one embodiment, the portion of the cacheable content 204 is transmitted to the device 102 as part of an invisible service. For example, in one embodiment, the cacheable content 204 is transmitted to the device by the transceiver logic 208 in a unicast transmission provided by the channel 220.

In one embodiment, the hybrid presentation system comprises program instructions stored on a computer-readable media, which when executed by a processor, for instance, the processing logic 202, provides the functions of the server 200 described herein. For example, instructions may be loaded into the server 200 from a computer-readable media, such as a floppy disk, CDROM, memory card, FLASH memory device, RAM, ROM, or any other type of memory device or computer-readable media. In another embodiment, the instructions may be downloaded into the server 200 from an external device or network resource that interfaces to the server 200 via the transceiver logic 208. The instructions, when executed by the processing logic 202, provide one or more embodiments of a hybrid presentation system as described herein. It should be noted that the server 200 is just one implementation and that other implementations are possible within the scope of the embodiments.

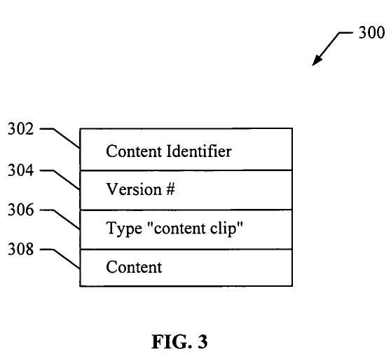

FIG. 3 shows one embodiment of cacheable content 300 for use in one or more embodiments of a hybrid presentation system. For example, one or more instances of the cacheable content 300 are suitable for use as the cacheable content 204 shown in FIG. 2. The cacheable content 300 comprises a content identifier 302, version indicator 304, type indicator 306, and actual content 308.

The content identifier 302 identifies the content 308. The version indicator 304 indicates the particular version of the content 308. The type indicator 306 indicates a type characteristic of the content 308. For example, the type indicator 306 may indicate that the content is a content clip, pop-up, script, program, or any other content type. The content 308 represents the actual content that is to be rendered on a device.

In one embodiment of a hybrid presentation system, one or more instances of the cacheable content 300 are transmitted and cached at a receiving device. The cached content 308 is then rendered on the device in response to on one or more operational conditions and/or presentation events. It should be noted that the format of the cacheable content 300 may be of any suitable type, and that the cacheable content 300 may also be encoded or encrypted using any suitable technique or technology.

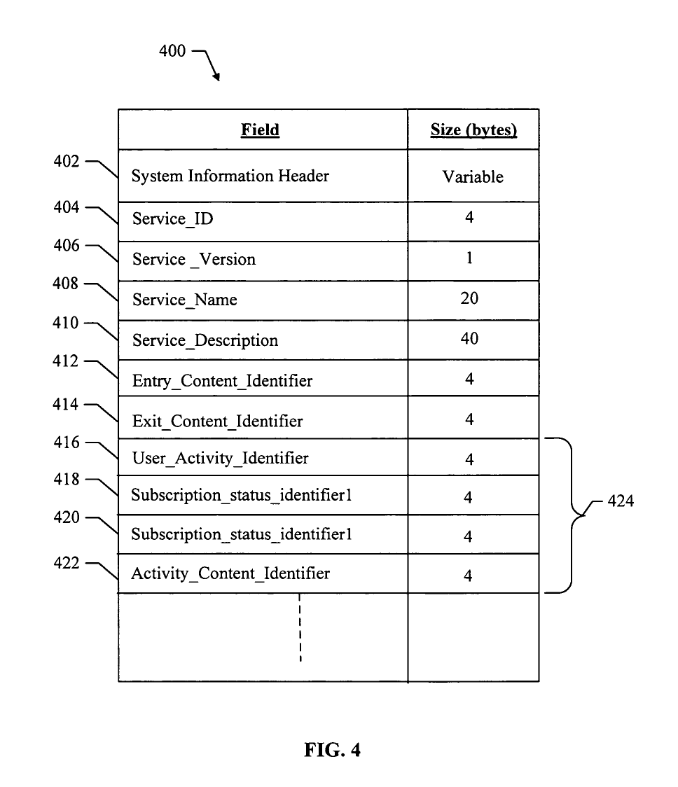

FIG. 4 shows one embodiment of system information 400 for use in one or more embodiments of a hybrid presentation system. For example, the system information 400 is suitable for use as the system information 214 shown in FIG. 2. In one embodiment, the system information 400 is assembled, updated, changed and/or otherwise maintained by the processing logic 202.

The system information 400 comprises one or more instances of a header 402, service identifier 404, service version indicator 406, service name 408, service description 410, entry content identifier 412, and exit content identifier 414. The system information 400 also comprises one or more instances of user activity parameters 424 that comprise a user activity identifier 416, subscription status identifiers (418, 420) and a content identifier 422.

The header 402 provides information identifying the system information 400, its version, or other information pertaining to the system information 400. The service identifier 404, version 406, name 408, and description 410 describe and identify a particular service. The entry content identifier 412 identifies content that is to be rendered when the identified service is obtained or joined. The exit content identifier 414 identifies content that is to be rendered when the identified service is exited, terminated, or unsubscribed.

The user activity identifier 416 identifies a specific user action with respect to the identified service 404. For example, the user action may be a response to a pop-up or other information request. The subscription status identifiers (418, 420) describe selected subscription status information. For example, the subscription status information may identify services to which the device may be subscribed.

The content identifier 422 identifies content to be rendered based upon the occurrence of the user activity parameters 424. In one or more embodiments, the system information 400 may comprise multiple instances of the user activity parameters 424 so that various predefined user activities can be associated with selected cached content. It should be noted that the format of the system information 400 may be of any suitable type and that it may also be encoded or encrypted using any suitable technique or technology.

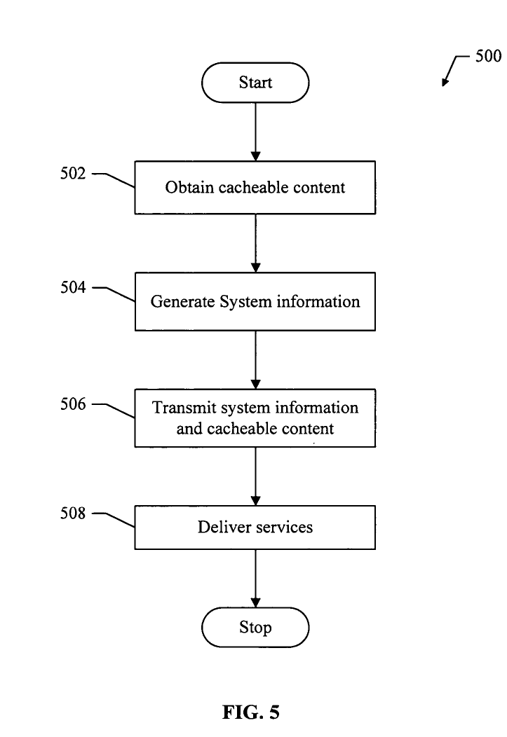

FIG. 5 shows one embodiment of a method 500 for operating a server in one embodiment of a hybrid presentation system. For clarity, the method 500 will be described with reference to the server 200 shown in FIG. 2. In one or more embodiments, the processing logic 202 executes program instructions and controls the operation of the server 200 to perform the functions described below. It will be assumed that the server 200 has activated one or more devices and has transmitted the client application 216 and package database 218 to those devices.

At block 502, the server obtains cacheable content that is associated with one or more services that are available. For example, the server 200 obtains the cacheable content 204 from a content retailer, service provider, or any other content provider. In one embodiment, the cacheable content 204 comprises non-real-time content clips, such as advertisements.

At block 504, system information parameters are generated. In one embodiment, the processing logic 202 operates to generate parameters for inclusion in the system information 214. For example, the processing logic 202 generates the system information parameters as shown in FIG. 4 that include entry content identifiers 412, exit content identifiers 414, and user activity parameters 424. The content identifiers identify content cached at a device that is to be rendered upon the occurrence of one or more presentation events.

At block 506, cacheable content and system information is transmitted to one or more devices. For example, in one embodiment, the processing logic 202 transmits the cacheable content 204 and the system information 214 to a device utilizing the channel 222 of the transceiver logic 208.

At block 508, services are transmitted over a data network. In one embodiment, the services are subscribed to by one or more devices. When one or more presentation events related to a delivered service occurs at a device, selected cached content identified in the system information at the device is rendered.

It should be noted that the method 500 illustrates just one implementation and that changes, additions, deletions, or rearrangements of the described functions may be made without deviating from the scope of the described embodiments.

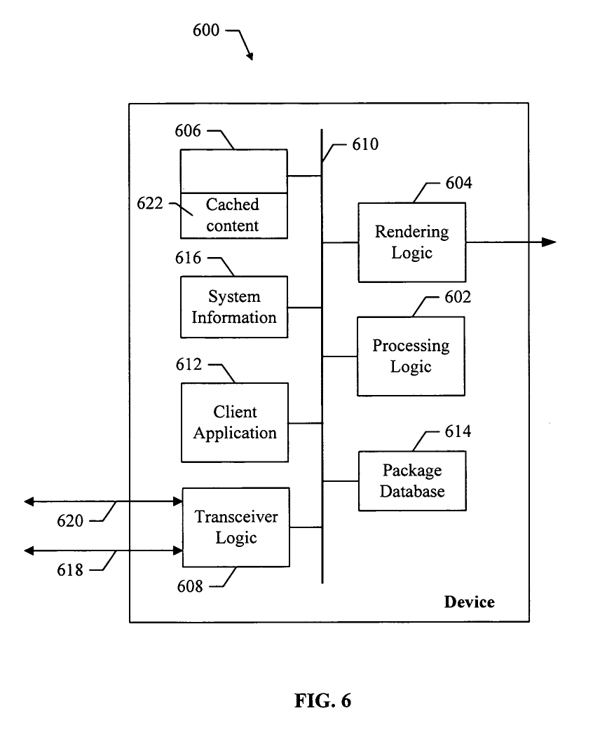

FIG. 6 shows a detailed diagram of one embodiment of a device 600 suitable for use in one or more embodiments of a hybrid presentation system. For example, the device 600 may be used as the device 102 in FIG. 1. The device 600 comprises processing logic 602, rendering logic 604, memory 606, and transceiver logic 608 all coupled to an internal data bus 610. The device also comprises client application logic 612, package database 614, and system information 616.

In one or more embodiments, the processing logic 602 comprises a CPU, processor, gate array, hardware logic, memory elements, virtual machine, software, and/or any combination of hardware and software. Thus, the processing logic 602 generally comprises logic to execute machine-readable instructions and to control one or more other functional elements of the device 600 via the internal data bus 610.

The rendering logic 604 comprises hardware and/or software that allow the device 600 to render content. For example, the rendering logic 604 may comprise audio logic, video logic, display systems, user interface logic and/or any other suitable hardware and/or software to allow the device to render content and to receive device inputs, such as input from a device user.

The memory 606 comprises any type of memory device suitable for storing information and content. For example, the memory 606 may operate as a cache memory to store content for subsequent rendering on the device 600.

The transceiver logic 608 comprises hardware and/or software that operate to allow the device 600 to transmit and receive data and/or other information with remote devices or network systems. In one embodiment, the transceiver logic 608 comprises logic configured to provide communications through a unicast communication channel 618. For example, in one embodiment, the communication channel 618 provides any suitable type of unicast link to allow the device 600 to communicate with one or more data networks. In one embodiment, the transceiver logic 608 comprises logic configured to provide communications through a multicast communication channel 620. For example, in one embodiment, the communication channel 620 provides any suitable type of multicast link to allow the device 600 to communicate with one or more data networks.

During operation, the device 600 activates with a server on a data network so that the device 600 may subscribe to receive available services. In on embodiment, the device 600 receives the client application 612, package database 614 and system information 616 from the server. The device also receives cacheable content, which is stored in the memory 606 as cached content 622. In one embodiment, the device 600 receives the above information through the transceiver logic 608 using the unicast communication channel 618.

In one embodiment, the client application 612 comprises any type of program or executable that executes on the device 600 to process the package database 614 and provide an interactive program guide to the device user. The client application 612 controls the rendering logic 604 to render the interactive program guide. The interactive program guide provides information about available services to the device user. The device user may then select one or more services to receive.

In one embodiment, a presentation event is detected by the client application 612. A presentation event is an event that operates to cause selected content in the cached content 622 to be rendered on the device. In one or more embodiments, a presentation event comprises one or more of the following events.
1. The device attempts to join or obtain a service.
2. The device attempts to exit or terminate a service.
3. A user activity is detected that is not part of joining or exiting a service.

In one embodiment, a presentation event occurs when the device attempts to join or obtain a selected service. For example, in one embodiment, the device user selects a service to join from the interactive program guide. The client application 612 operates to process information in the system information 610 associated with the selected service. The system information 610 comprises an entry content identifier that identifies cached entry content that is to be rendered. In one embodiment, the entry content is part of the cached content 622. The client application 612 then retrieves the identified entry content from the cached content 622 and renders it on the device 600 using the rendering logic 604. The client application 612 then operates to control the transceiver logic to obtain the selected service. For example, the service may be received as a multicast transmission using the communication channel 620. Thus, in one embodiment of a hybrid presentation system, selected content from the cached content 622 is rendered when the device attempts to join or obtain a service.

In one embodiment, a presentation event occurs when the device attempts to exit or terminate a selected service. For example, in one embodiment, the device user selects a service to exit from the interactive program guide. For example, the device 600 is currently subscribed to receive the selected service. The client application 612 operates to process information in the system information 610 associated with the selected service. The system information 610 identifies an exit content identifier that identifies exit content that is to be rendered for the selected service. In one embodiment, the exit content is part of the cached content 622. The client application logic 612 then retrieves the identified exit content from the cached content 622 and renders it on the device 600 using the rendering logic 604. The client application logic 612 then operates to transmit a request to a server to exit the selected service. For example, the request is transmitted using the transceiver logic 608 and communication channel 618. Thus, in one embodiment of a hybrid presentation system, selected content from the cached content 622 is rendered when the device attempts to exit a service.

In one embodiment, a presentation event occurs when a selected user activity occurs. For example, in one embodiment, the device user takes a selected action with respect to a service. For example, the action may comprise responding to a pop-up, selecting a particular link, or any other action. Each action is associated with an identifier. When the user performs a selected action, the client application 612 operates to process information in the system information 610 to determine if cached content should be rendered. For example, the client application 612 tests the identifier of the user action against identified actions (i.e., 416 of FIG. 4) in the system information 610 to determine if there is a match. If there is a match, the system information 610 identifies content that is to be rendered (i.e., 422 of FIG. 4). In one embodiment, the content is part of the cached content 620. The client application 612 then retrieves the identified content from the cached content 622 and renders it on the device 600 using the rendering logic 604.

In one embodiment, a presentation event occurs based on a user subscription status. For example, in one embodiment, the client application 612 determines if a selected subscription status exists for the device. For example, the client application 612 determines if the device is subscribed to services identified by the subscription status identifiers 418, 420 in the system information. For example, in one embodiment, the device comprises locally stored information that identifies the services to which the device is subscribed. That locally stored information is compared to the subscription status identifiers 418, 420 in the system information to determine the device's subscription status. If the device's subscription status matches the identifiers in the system information, then content identified by the content identifier 422 is rendered on the device. For example, the client application 612 operates to process information in the system information 610 associated with the selected subscription status. The system information 610 identifies content to be rendered that is part of the cached content 622. The client application 612 then retrieves the identified content from the cached content 622 and renders it on the device 600 using the rendering logic 604. Thus, it is possible for the rendering of selected cached content to be conditioned on the subscription status of the device. As a result, devices having selected subscription status may be targeted to render selected cached content. For example, devices subscribed to one or more sports related services may be targeted to render sports related advertisements.

In one embodiment, the hybrid presentation system comprises program instructions stored on a computer-readable media, which when executed by a processor, for instance, the processing logic 602, provides the functions of the hybrid presentation system described herein. For example, instructions may be loaded into the device 600 from a computer-readable media, such as a floppy disk, CDROM, memory card, FLASH memory device, RAM, ROM, or any other type of memory device or computer-readable media. In another embodiment, the instructions may be downloaded into the device 600 from an external device or network resource that interfaces to the device 600 via the transceiver logic 608. The instructions, when executed by the processing logic 602, provide one or more embodiments of a hybrid presentation system as described herein.

It should be noted that the device 600 illustrates just one implementation and that other implementations are possible within the scope of the embodiments.

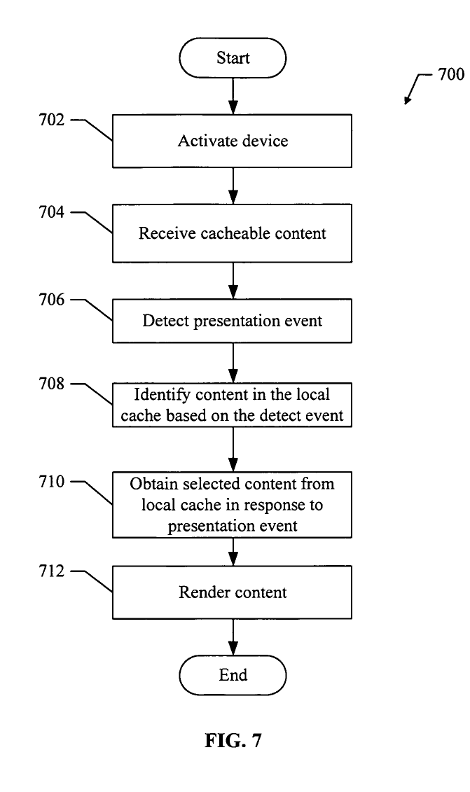

FIG. 7 shows one embodiment of a method 700 for operating a device in one embodiment of a hybrid presentation system. For clarity, the method 700 will be described with reference to the device 600 shown in FIG. 6. In one or more embodiments, the processing logic 602 executes program instructions to control the device 600 to perform the functions described below.

At block 702, the device takes part in an activation process that allows the device to subscribe to receive available services from a network server. For example, as part of the activation process, the device 600 receives the client application 612, the package database 614 and the system information 616 through the transceiver logic 608.

At block 704, cacheable content is received at the device. For example, a network server transmits cacheable content to the device 600 that is received by the transceiver logic 608 and stored as cached content 622 in the memory 606. In one embodiment, the received cacheable content comprises content clips, programs, scripts, or any other type of cacheable information.

At block 706, a presentation event is detected at the device. For example, the presentation event comprises one or more events that cause the client application 612 to retrieve and render content from the cached content 622. For example, the presentation events comprise the presentation events described above. A more detailed description of the operation of block 706 is provided in the description of FIG. 9 below.

At block 708, based on the detected presentation event, selected content in the locally cached content is identified. For example, based on the detected presentation event, the client application 612 obtains a content identifier that identifies content in the locally cached content 622. A more detailed description of the operation of block 708 is provided in the description of FIG. 9 below.

At block 710, the identified content in the locally cached content is retrieved. For example, in one embodiment, the client application 612 retrieves the identified content from the cached content 622.

At block 712, the retrieved content is rendered on the device. In one embodiment, the client application 612 controls the rendering logic 604 to render the retrieved cached content 622 on the device 600.

Thus, the method 700 allows a device to operate according to one embodiment of a hybrid presentation system to render selected content from locally cached content based on a presentation event. It should be noted that the method 700 illustrates just one implementation and that changes, additions, or rearrangements of the functional elements may be made without deviating from the scope of the described embodiments.

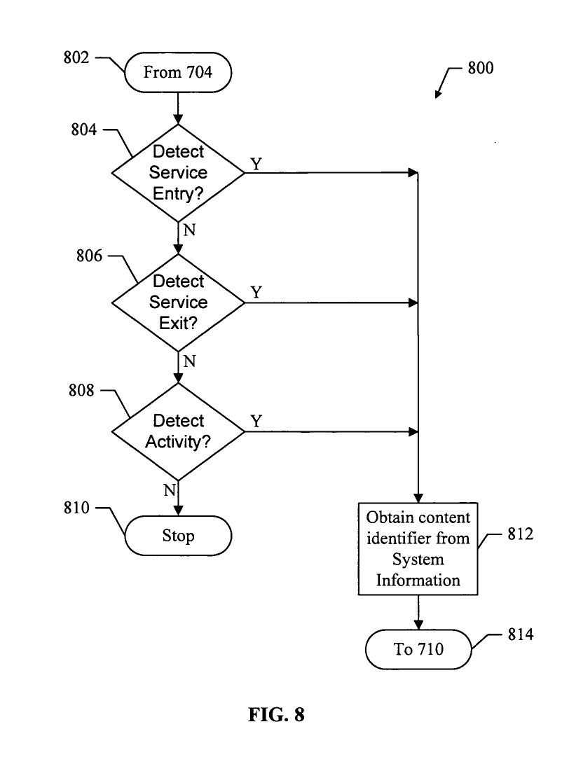

FIG. 8 shows one embodiment of a method 800 for operating a device to detect a presentation event in one embodiment of a hybrid presentation system. For example, the method 800 is suitable for use in blocks 706 and 708 of the method 700 shown in FIG. 7. In one embodiment, the method 800 is entered into from block 704 of FIG. 7, as shown by block 802.

At block 804, a test is performed to determine if a service entry is detected. For example, a service entry occurs when the device user selects a service to receive or join from the interactive program guide provided by the client application 612. If a service is to be entered, the method proceeds to block 814. If a service is not to be entered, the method proceeds to block 806.

At block 806, a test is performed to determine if a service exit is detected. For example, a service exit occurs when the device user selects a service to exit or terminate from the interactive program guide provided by the client application 612. If a service is to be exited, the method proceeds to block 814. If a service is not to be exited, the method proceeds to block 808.

At block 810, a test is performed to determine if the user has performed a specific user activity. For example, in one embodiment, the user activity is a selected response to a request for information. In another embodiment, the user activity is based on the subscription status of the device. In one embodiment, this test is performed by the client application 612 as describe above. If the selected user activity is detected, the method proceeds to block 812. If the selected user input is not detected, the method proceeds to block 810.

At block 812, selected content is retrieved from a local cache based on a content identifier located in a system information file. For example, in one embodiment, the client application 612 determines that a service entry, service exit, or a selected user activity has occurred. The client application 612 then accesses the system information 616 to obtain a content identifier associated with the selected service and based on the detected presentation event. The content identifier identifies content in the cached content 622 that is to be rendered as a result of the detected presentation event. The method then proceeds to block 710 of the method 700 where the identified cached content is retrieved and rendered.

Thus, the method 800 operates to allow a device to detect one or more presentation events in one embodiment of a hybrid presentation system. Once a presentation event has been detected, a selected content identifier is obtained that identifies selected content in locally cached content. The selected content is then rendered on the device. It should be noted that the method 800 illustrates just one implementation and that changes, additions, or rearrangements of the functional elements may be made without deviating from the scope of the described embodiments.

Accordingly, while one or more embodiments of a hybrid presentation system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for rendering hybrid presentations, the method comprising:
caching one or more content items;
detecting a presentation event associated with a real-time service;
retrieving a selected content item from the one or more content items based on the presentation event; and
rendering the selected content item.

2. The method of claim 1, wherein said detecting comprises detecting a selection to receive the real-time service.

3. The method of claim 2, wherein said retrieving comprises retrieving the selected content item from the one or more content items based on an entry content identifier associated with the real-time service.

4. The method of claim 1, wherein said detecting comprises detecting a selection to exit the real-time service.

5. The method of claim 4, wherein said retrieving comprises retrieving the selected content item from the one or more content items based on an exit content identifier associated with the real-time service.

6. The method of claim 1, wherein said detecting comprises detecting a selected user activity associated with the real-time service.

7. The method of claim 6, wherein said retrieving comprises retrieving the selected content item from the one or more content items based on a content identifier associated with the user activity.

8. The method of claim 1, wherein said detecting comprises detecting a selected subscription status associated with the device.

9. The method of claim 8, wherein said retrieving comprises retrieving the selected content item from the one or more content items based on a content identifier associated with the selected subscription status.

10. Apparatus for rendering hybrid presentations, the apparatus comprising:
memory configured to cache one or more content items;
client application logic configured to detect a presentation event associated with a real-time service, and to retrieve selected content item from the one or more content items based on the presentation event; and
rendering logic configured to render the selected content item.

11. The apparatus of claim 10, wherein said client application logic detects the presentation event when a real-time service is joined.

12. The apparatus of claim 10, wherein said client application logic detects the presentation event when a real-time service is exited.

13. The apparatus of claim 10, wherein said client application logic detects the presentation event when a selected user action is detected.

14. The apparatus of claim 10, wherein said client application logic detects the presentation event based on a selected subscription status.

15. The apparatus of claim 10, wherein the client application logic further comprises logic configured to access system information to obtain a content identifier that identifies the selected content.

16. Apparatus for rendering hybrid presentations, the apparatus comprising:
means for caching one or more content items;
means for detecting a presentation event associated with a real-time service;
means for retrieving a selected content item from the one or more content items based on the presentation event; and
means for rendering the selected content item.

17. The apparatus of claim 16, wherein said means for detecting comprises means for detecting a selection to receive the real-time service at the device.

18. The apparatus of claim 17, wherein said means for retrieving comprises means for retrieving the selected content item from the one or more content items based on an entry content identifier associated with the real-time service.

19. The apparatus of claim 16, wherein said means for detecting comprises means for detecting a selection to exit the real-time service.

20. The apparatus of claim 19, wherein said means for retrieving comprises means for retrieving the selected content item from the one or more content items based on an exit content identifier associated with the real-time service.

21. The apparatus of claim 16, wherein said means for detecting comprises means for detecting a selected user activity associated with the real-time service.

22. The apparatus of claim 21, wherein said means for retrieving comprises means for retrieving the selected content item from the one or more content items based on a content identifier associated with the user activity.

23. The apparatus of claim 16, wherein said means for detecting comprises means for detecting a selected subscription status associated with the device.

24. The apparatus of claim 23, wherein said means for retrieving comprises means for retrieving a selected content item from the one or more content items based on a content identifier associated with the selected subscription status.

25. A computer-readable medium comprises instructions, which when executed by processing logic, operate to render hybrid presentations, the computer-readable medium comprising:
instructions for caching one or more content items;
instructions for detecting a presentation event associated with a real-time service;
instructions for retrieving a selected content item from the one or more content items based on the presentation event; and
instructions for rendering the selected content item.

26. The computer-readable medium of claim 25, wherein said instructions for detecting comprise instructions for detecting a selection to receive the real-time service at the device.

27. The computer-readable medium of claim 26, wherein said instructions for retrieving comprise instructions for retrieving the selected content item from the one or more content items based on an entry content identifier associated with the real-time service.

28. The computer-readable medium of claim 25, wherein said instructions for detecting comprise instructions for detecting a selection to exit the real-time service.

29. The computer-readable medium of claim 28, wherein said instructions for retrieving comprise instructions for retrieving the selected content item from the one or more content items based on an exit content identifier associated with the real-time service.

30. The computer-readable medium of claim 25, wherein said instructions for detecting comprise instructions for detecting a selected user activity associated with the real-time service.

31. The computer-readable medium of claim 30, wherein said instructions for retrieving comprise instructions for retrieving the selected content item from the one or more content items based on a content identifier associated with the user activity.

32. The computer-readable medium of claim 25, wherein said instructions for detecting comprise instructions for detecting a selected subscription status associated with the device.

33. The computer-readable medium of claim 32, wherein said instructions for retrieving comprise instructions for retrieving a selected content item from the one or more content items based on a content identifier associated with the selected subscription status.

34. At least one processor configured to perform a method for rendering hybrid presentations, the method comprising:
caching one or more content items;
detecting a presentation event associated with a real-time service;
retrieving a selected content item from the one or more content items based on the presentation event; and
rendering the selected content item.

35. The processor of claim 34, wherein said detecting comprises detecting a selection to receive the real-time service at the device.

36. The processor of claim 35, wherein said retrieving comprises retrieving the selected content item from the one or more content items based on an entry content identifier associated with the real-time service.

37. The processor of claim 34, wherein said detecting comprises detecting a selection to exit the real-time service.

38. The processor of claim 37, wherein said retrieving comprises retrieving the selected content item from the one or more content items based on an exit content identifier associated with the real-time service.

39. The processor of claim 34, wherein said detecting comprises detecting a selected user activity associated with the real-time service.

40. The processor of claim 39, wherein said retrieving comprises retrieving the selected content item from the one or more content items based on a content identifier associated with the user activity.

41. The processor of claim 34, wherein said detecting comprises detecting a selected subscription status associated with the device.

42. The processor of claim 41, wherein said retrieving comprises retrieving a selected content item from the one or more content items based on a content identifier associated with the selected subscription status.

43. A method for rendering hybrid presentations, the method comprising:
generating system information parameters for one or more real-time services, wherein the system information parameters associate a presentation event with a cacheable content item;
transmitting the system information parameters.

44. The method of claim 43, wherein said presentation event comprises determining an entry to a real-time service.

45. The method of claim 43, wherein said presentation event comprises determining an exit from a real-time service.

46. The method of claim 43, wherein said presentation event comprises determining a selected device user activity.

47. The method of claim 43, wherein said presentation event comprises a determining a selected device subscription status.

48. Apparatus for rendering hybrid presentations, the apparatus comprising:
logic for generating system information parameters for one or more real-time services, wherein the system information parameters associate a presentation event with a cacheable content item;
logic for transmitting the system information parameters.

49. The apparatus of claim 48, wherein said presentation event comprises determining an entry to a real-time service.

50. The apparatus of claim 48, wherein said presentation event comprises determining an exit from a real-time service.

51. The apparatus of claim 48, wherein said presentation event comprises determining a selected device user activity.

52. The apparatus of claim 48, wherein said presentation event comprises a determining a selected device subscription status.
